(19) United States
(12) Patent Application Publication
(10) Pub. No.: US 2006/0221911 A1
(43) Pub. Date: Oct. 5, 2006

(54) Mechanism for the hidden node problem in a wireless network

(76) Inventor: Shay Waxman, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/093,708

(22) Filed: Mar. 30, 2005

(51) Int. Cl. H04Q 7/24

(52) U.S. Cl. 370/338

(57) ABSTRACT

A method for improving the hidden-node problem in a wireless network comprises detecting a power back-off initiated at a data portion of a transmitted packet.

### FIELD OF THE INVENTION

The present embodiments of the invention relate generally to wireless communications, and more specifically, relate to the hidden-node problem in a wireless network.

### BACKGROUND

When a station or access point (AP) transmits a high-rate packet (for example, a 54 Mbps rate packet) in a wireless local area network (WLAN), it is usually transmitted with a lower power than that of a low-rate packet (for example, a 6 Mbps packet). This is referred to as a “power back-off,” with the exact amount of power being reduced measures in decibels (dB). A typical back-off for the 54 Mbps rate versus the 6 Mbps rate is approximately 7 dB.

Generally, power back-off is applied in order to meet transmit Error Vector Magnitude (EVM) and mask specifications received in the Institute of Electrical and Electronics Engineers) (IEEE) 802.11a standard (IEEE std. 802.11a-1999) [hereinafter 802.11a] and the IEEE 802.11g standard (IEEE std. 802.11g-2003) [hereinafter 802.11g].

Remote stations that receive and/or detect the low-rate packet from the AP or station may not, in some situations, receive or detect the high-rate packet transmitted by this same AP or station. As a result of not detecting the high-rate packet, multiple remote stations may transmit simultaneously and cause a packet collision in the network. This problem is referred to as the “hidden node” problem.

### BRIEF DESCRIPTION OF THE DRAWINGS

The present invention will be understood more fully from the detailed description given below and from the accompanying drawings of various embodiments of the invention. The drawings, however, should not be taken to limit the invention to the specific embodiments, but are for explanation and understanding only.

FIG. 1 illustrates an exemplary wireless communication station in accordance with embodiments of the invention;

FIG. 2 illustrates a block diagram of a wireless network system in accordance with exemplary embodiments of the invention;

FIG. 3 illustrates a time-slot diagram demonstrating the operation of a wireless network station in an exemplary scenario;

FIG. 4 illustrates a time-slot diagram demonstrating the operation of a wireless network station in accordance with one embodiment of the invention;

FIG. 5 is a flow diagram depicting a method according to one embodiment of the invention; and

FIG. 6 is a flow diagram depicting a method according to another embodiment of the invention.

### DETAILED DESCRIPTION

An apparatus and method to improve the hidden-node problem in a wireless network are described. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

In the following description, numerous details are set forth. It will be apparent, however, to one skilled in the art, that the embodiments of the invention may be practiced without these specific details. In other instances, well-known structures and devices are shown in block diagram form, rather than in detail, in order to avoid obscuring the present invention.

It should be understood that embodiments of the invention may be used in a variety of applications. Although the invention is not limited in this respect, embodiments of the invention may be used in many apparatuses, for example, a modem, a personal computer, a desktop computer, a mobile computer, a laptop computer, a notebook computer, a Personal Digital Assistant (PDA) device, a tablet computer, a server computer, a network, a Local Area Network (LAN), a Wireless LAN (WLAN), a modem, a wireless modem, a wireless communication device, devices and/or networks operating in accordance with the existing 802.11a, 802.11b (IEEE std. 802.11b-1999) [hereinafter 802.11b], 802.11g, 802.11n (IEEE std. 802.11bn-2003) [hereinafter 802.11n] and/or future versions of the above standards, a Personal Area Network (PAN), Wireless PAN (WPAN), Wireless Metropolitan Area Network (WMAN), Wireless Wide Area Network (WWAN), units and/or devices which are part of the above WLAN, PAN, WPAN, WMAN, and/or WWAN networks, one-way and two-way radio communication systems, and the like.

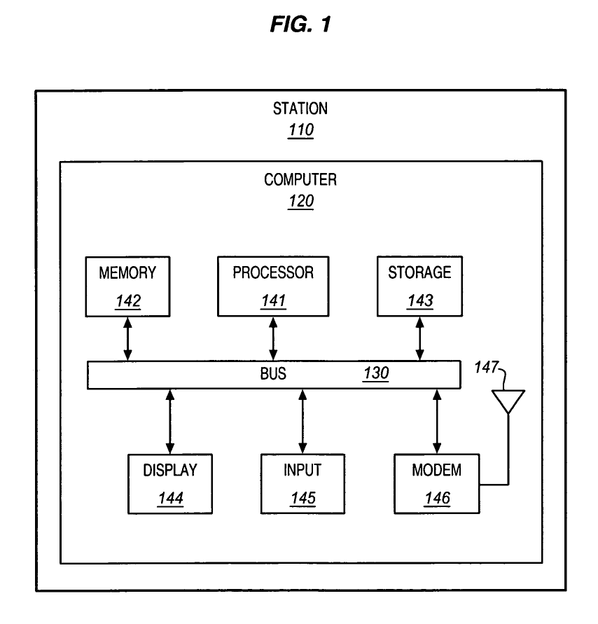

Referring to FIG. 1, a wireless communication station in accordance with embodiment of the invention is shown. Station 110 may operate using a power back-off feature in accordance with embodiments of the invention, as described below. Throughout this description, a station may also be referred to as a remote station.

In some embodiments, station 110 may include a personal computer, a desktop computer, a mobile computer, a laptop computer, a notebook computer, a Personal Digital Assistant (PDA) device, a tablet computer, a network device, a network, an internal and/or external modem, fax-modem device and/or card, a peripheral device, a WLAN device, or the like.

In the exemplary embodiment of FIG. 1, station 110 may include a computer 120, which may include a processor 141, a memory unit 142, a storage unit 143, a display unit 144, an input unit 145, a modem 146, and an antenna 147, all interconnected through bus 130.

Processor 141 may include, for example, a Central Processing Unit (CPU), a Digital Signal Processor (DSP), or any suitable specific, general, or multi-purpose processor or micro-processor.

Memory 142 may include, for example, a Random Access Memory (RAM). Storage unit 143 may include, for example, a hard disk drive. Display unit 144 may include, for example, a monitor. Input unit 145 may include, for example, a keyboard, a mouse, or a touch-pad.

Modem 146 may include, for example, a modem able to operate in accordance with one or more of the existing 802.11a, 802.11b, 802.11g, 802.11n standards and/or any future versions of these standards, or any other suitable existing or future versions of these standards. Antenna 147 may include an internal and/or external Radio Frequency (RF) antenna, for example, a dipole antenna. In some embodiments, antenna 147 may be integral to modem 146 or integrated within modem 146.

It is noted that in some embodiments, modem 146 may include a detector unit to detect properties of the signals received by station 110. In some embodiments, such detection may be performed by other suitable components of station 110 or computer 120, for example, processor 141 or software applications, driver, and operations systems associated with station 110 or computer 120.

It is noted that station 110 and/or computer 120 may include various other components and may be configured with additional or alternative units. Further, stations 110 and computer 120 may be implemented using any suitable combination of hardware and/or software, and may include any circuit, circuitry, unit, or combination of integrated or separate units or circuits, as are known in the art, to perform desired functionalities.

It is noted that the terms “circuit” and “circuitry” as used herein, may include any suitable combination of hardware components and/or software components. For example, station 110 may include detection circuitry, analysis circuitry, selection circuitry, comparison circuitry, processing circuitry, reception circuitry, engagement circuitry, reset circuitry, storage circuitry, one or more analyzer units, comparison units, decision units, processing units, storage units, detection units, buffers, memories, and various other types of units, components, and/or circuitry, which may be used to perform methods and operations as discussed below in accordance with exemplary embodiments of the invention, and which may be implemented using any suitable combination of hardware components and/or software components (including, for example, applications, drivers, and/or operating systems) of station 110.

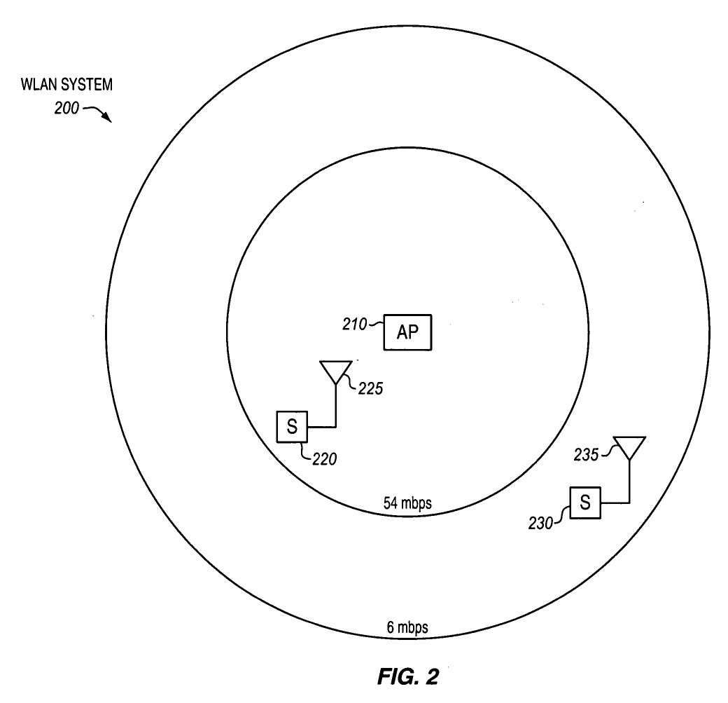

Referring to FIG. 2, a wireless network system, in accordance with embodiments of the invention, is shown. In one embodiment, system 200 may include a network access station 210 such as an access point (AP), base station, hybrid coordinator, wireless router or other device (for simplicity referred to hereafter as an AP). System 200 also includes a remote station 220 and, optionally, an additional remote station 230. In some embodiments, system 200 may further include one or more APs similar to AP 210, and one or more additional stations similar to station 220. In some embodiments, AP 210 and stations 220, 230 are the same as station 110 as depicted in FIG. 1.

Remote stations 220, 230 may be any device such as an AP or user station configured to communicate with AP 210 using one or more over-the-air (OTA) link protocols such as those contemplated by various IEEE standards for WPANs, WMANs, or WWANs. In certain embodiments, remote stations 220, 230 include one or more transceivers and circuitry for physical (PHY) layer and data link layer (medium access control (MAC)) processing although the embodiments are not limited in this respect.

In one embodiment, AP 210 may include any suitable WLAN access point circuitry, for example, access point circuitry able to operate in accordance with one or more of the existing 802.11a, 802.11b, 802.11g, and 802.11n standards or future versions of those standards or any other suitable existing and/or future standard.

Optionally, stations 220, 230 may include one or more antennas 225, 235. Antenna 225, 235 may include an internal and/or external RF antenna, for example, a dipole antenna. In some embodiments, antenna 225, 235 may be integral to the circuitry of station 220, 230 or otherwise integrated within station 220, 230. In certain embodiments, multiple antennas may be used for each station 220, 230 to facilitate multiple input multiple output (MIMO) communications.

It will be appreciated that the term “signal” as used herein may include, for example, a signal, a packet, a frame, a data structure, a preamble, a header, a content and/or a data portion, which may be transmitted and received in accordance with various formats and standards.

It will be appreciated that, although the scope of the invention is not limited in this respect, the term “receive”, and its derivative terms (e.g., “receiving”, “reception”), as used herein, may include, for example, physically receiving a signal using an antenna, receiver, transceiver, and/or modem. It may also include physically receiving a wireless communication transmission, receiving energy indicating a wireless communication transmission, and/or physically receiving a signal over a wireless communication link, network, and/or WLAN.

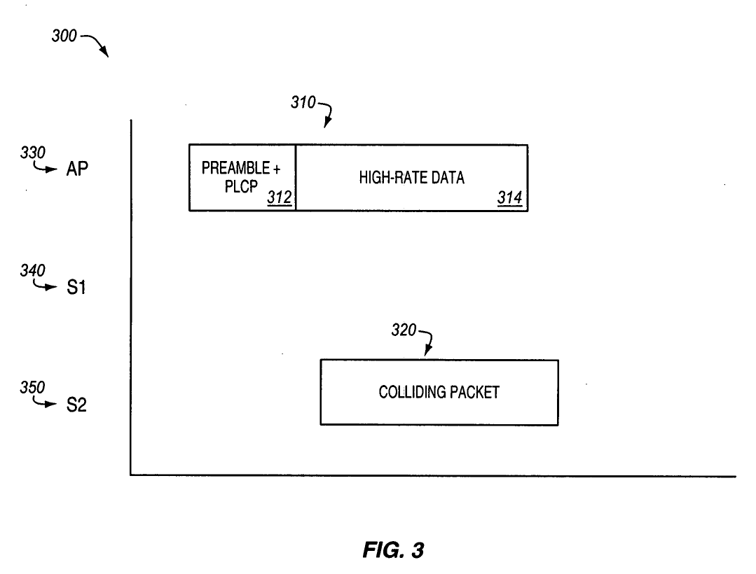

Referring to FIG. 3, a time-slot diagram is shown. The time-slot diagram 300 depicts the operation of a WLAN system. The WLAN system includes an AP 330 and two remote stations 340, 350.

The AP 330 may transmit a signal 310 to a remote station in the WLAN system, such as remote station 340. Signal 310 is a high-rate transmission packet that may consist of a preamble portion 312 and a data portion 314. As signal 310 is a high-rate data transmission packet, AP 330 transmits the signal 310 with a power back-off in order to meet requirements of various wireless standards.

However, in some situations, station 350 may not receive or even detect the high-rate packet 310. For example, referring to FIG. 2, the range of a 54 Mbps transmission has a much smaller radius than the range of a 6 Mbps transmission, due to the power requirements for each transmission rate. As a result, station 350 may not receive a packet transmitted at 54 Mbps. If station 350 does not detect packet 310, it may transmit its own packet 320 and cause a collision in the network. This is generally known as the “hidden node” problem.

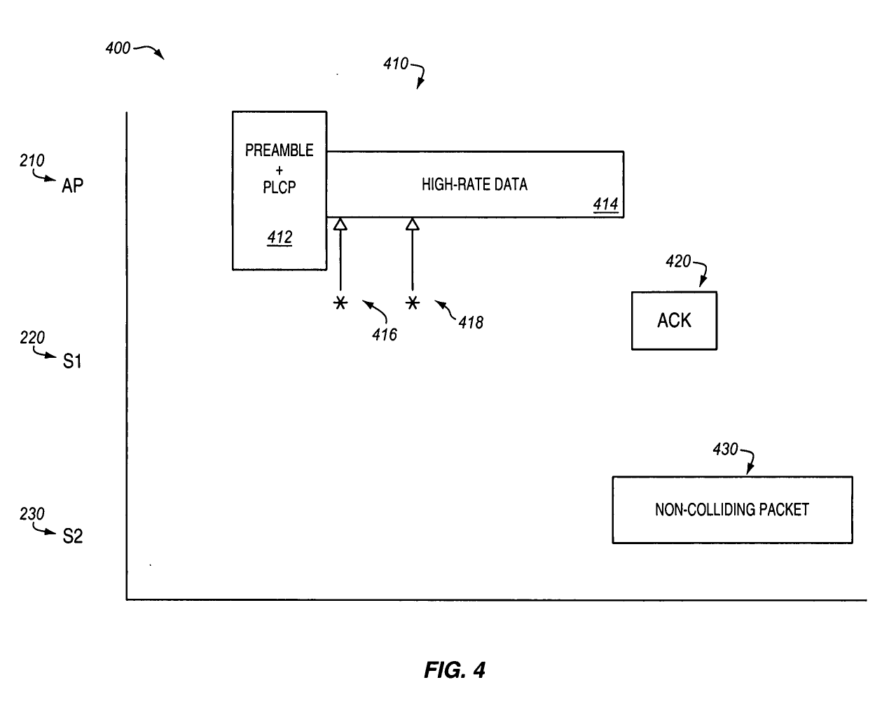

Referring to FIG. 4, a time-slot diagram in accordance with embodiments of the present invention, is shown. The time-slot diagram 400 depicts the operation of a WLAN system in accordance with embodiments of the present invention. In one embodiment, WLAN system is the same as WLAN system 200 as depicted in FIG. 2, and includes an AP 210, and two remote stations 220, 230.

AP 210 may transmit a signal 410, including preamble portion 412 and data portion 414, to a remote station in the WLAN system 200, such as remote station 220. In some embodiments, the preamble portion 312 of the packet may include Physical Layer Convergence Procedures (PLCP). Signal 410 is a high-rate transmission packet, such as an 802.11a/g Orthogonal Frequency Division Multiplexing (OFDM) packet. However, in lieu of applying a power back-off to the entire high-rate packet 410, the AP 210 applies a power back-off to the data portion 414 of the packet 410 and not to the preamble portion 412.

The preamble portion 412 of the packet 410 is digitally boosted with high power so that all of the remote stations 220, 230 may detect the signal 410. Although the preamble portion 412 may be distorted due to the transmission rate and power level, it can be properly decoded by the remote stations 220, 230 to determine the length of the packet 410. Once the stations determine the length of the packet 410, they will be able to wait until the end of the transmission to send their own packets.

Remote station 220 may send an acknowledgement packet 420 once it has received the high-rate data packet 410. In this way, collision is prevented because remote station 230, which would normally not detect the high-rate packet, detects a packet being transmitted in the WLAN system 200 and waits to send its own non-colliding packet 430. As a result, the number of hidden nodes in the WLAN system 200 will drop dramatically (assuming uniform distribution of stations in the cell).

Transmitting the packet 410 using digitally-boosted, higher power in the preamble 412 may impose a problem to a conventional receiver that would set its automatic gain control (AGC) and calculate its equalizer according to the higher-power preamble 412. In order to receive the data in the data portion 414, an improved receiver may implement one of two alternate arrangements.

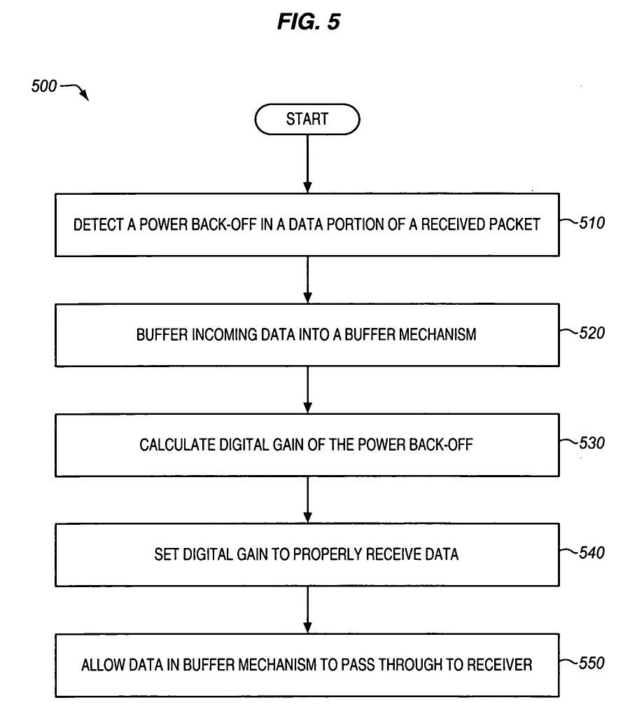

Referring to FIG. 5, a method according to one embodiment of the invention is shown. The method 500 implements one arrangement for a receiver to receive high-rate, low-power data portions of a packet with a digitally-boosted preamble.

At processing block 510, a power-back off in a data portion of a received packet is detected. Then, the incoming data is buffered in a buffer mechanism at processing block 520. At processing block 530, the digital gain of the detected power-back off is calculated. Then, at processing block 540, the digital gain is set so that the data will be properly received. At processing block 550, the data is passed on from the buffer mechanism.

It should be noted that other storage means may be implemented in lieu of a buffer mechanism. Any means that provide temporary storage for data while the receiver calculates and sets the gain may be utilized in embodiments of the invention.

The buffering of data in method 500 may create a high latency which could be problematic with short packets. Therefore, in one embodiment, power back-off during data transmission of short packets is not implemented.

With the embodiment described above, power back-off during data transmission can be applied to all remote stations and APs. For example, the embodiment could be implemented in an ad hoc network among various remote stations.

Furthermore, this embodiment allows Network Interface Card (NIC) vendors, and not only APs, to introduce this feature and contribute to the improvement of the hidden node problem. As a result, NIC vendors may contribute to the Basic Service Set (BSS) capacity.

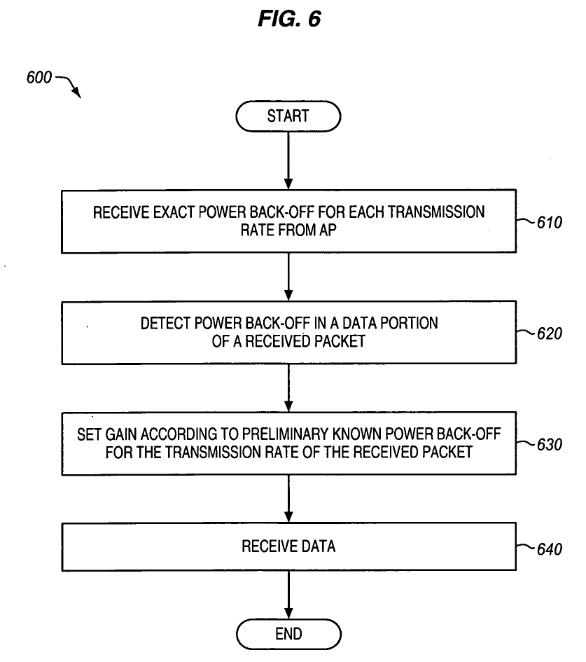

Referring to FIG. 6, a method according to another embodiment of the invention is shown. The method 600 implements an alternative arrangement for a receiver to receive high-rate, low-power data portions of a packet with a digitally-boosted preamble portion.

At processing block 610, each remote station receives the exact power back-off for each transmission rate from the AP. Then, at processing block 620, the receiver detects a power back-off in the data portion of a received packet. At processing block 630, the receiver sets the preliminarily-known digital gain value accordingly to receive the data. In some embodiments, the digital gain value is a function of the RATE field in the PLCP. Then, at processing block 640, the data is received.

In this embodiment, power back-off is not calculated when a power back-off is detected because the receiver already knows the exact power back-off. Also, as the receiver already knows the power back-off, it does not have to buffer the data while it calculates the power back-off. However, power back-off during data transmission may only be implemented by the AP transmitter. As such, remote station to remote station transmissions may not implement power back-off.

In some embodiments, stations that are not able to receive a packet with power back-off, such as legacy stations, will only receive the preamble portion and wait an Extended InterFrame Space (EIFS) instead of a Distributed InterFrame Space (DIFS) before transmitting.

During an association period, the AP and remote stations exchange their capabilities regarding support of power back-off only in the data section of a packet. In some embodiments, such a capability exchange may include: a bit to indicate the ability to receive the data back-off packet; minimal payload length for which data back-off is implemented; and a list of power back-offs for each rate to support receivers that preliminary know the power back-off values. In some embodiments, the AP controls whether or not the “data power back-off” mechanism is turned on in the stations by using a beacon with a dedicated one bit field.

Various embodiments of the invention may be provided as a computer program product, which may include a machine-readable medium having stored thereon instructions, which may be used to program a computer (or other electronic devices) to perform a process according to various embodiments of the invention. The machine-readable medium may include, but is not limited to, floppy diskette, optical disk, compact disk-read-only memory (CD-ROM), magneto-optical disk, read-only memory (ROM) random access memory (RAM), erasable programmable read-only memory (EPROM), electrically erasable programmable read-only memory (EEPROM), magnetic or optical card, flash memory, or another type of media/machine-readable medium suitable for storing electronic instructions. Moreover, various embodiments of the invention may also be downloaded as a computer program product, wherein the program may be transferred from a remote computer to a requesting computer by way of data signals embodied in a carrier wave or other propagation medium via a communication link (e.g., a modem or network connection).

Similarly, it should be appreciated that in the foregoing description, various features of the invention are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as the invention.

What is claimed is:

1. A method, comprising detecting a power back-off initiated at a data portion of a transmitted packet.

2. The method of claim 1, further comprising:
buffering incoming data of the data portion of the transmitted packet;
calculating a digital gain of the detected power back-off;
setting the digital gain to properly receive the data; and
receiving the data of the transmitted packet.

3. The method of claim 1, further comprising:
receiving an exact power back-off for each transmission rate;
determining a transmission rate for the transmitted packet;
setting a digital gain according to the exact power back-off for the transmission rate; and
receiving the data of the transmitted packet.

4. The method of claim 1, wherein a station that the transmitted packet was not directed to waits to send a separate packet until the transmitted packet is received.

5. The method of claim 1, wherein the transmitted packet is a Orthogonal Frequency Division Multiplexing (OFDM) packet.

6. The method of claim 1, wherein a preamble portion of the transmitted packet is digitally boosted and does not have power back-off.

7. The method of claim 6, wherein the preamble portion includes Physical Layer Convergence Procedures (PLCP).

8. A machine-readable medium having stored thereon a set of instructions that, if executed by a machine, cause the machine to perform operations comprising receiving a transmitted packet having a preamble portion and a data portion, wherein only the data portion includes a power back-off.

9. The machine-readable medium of claim 8, further including instructions that cause the machine to perform operations comprising:
buffering the incoming data of the data portion of the packet;
calculating a digital gain of the power back-off;
setting the digital gain to properly receive the data portion; and
receiving the data portion of the transmitted packet.

10. The machine-readable medium of claim 8, further including instructions that cause the machine to perform operations comprising:
receiving an exact power back-off for each transmission rate;
determining a transmission rate for the transmitted packet;
setting a digital gain according to the exact power back-off for the transmission rate; and
receiving the data portion of the transmitted packet.

11. The machine-readable medium of claim 8, wherein the transmitted packet is a Orthogonal Frequency Division Multiplexing (OFDM) packet.

12. The machine-readable medium of claim 8, wherein the preamble portion of the transmitted packet is digitally boosted and does not have power back-off.

13. The machine-readable medium of claim 12, wherein the preamble portion includes Physical Layer Convergence Procedures (PLCP).

14. The machine-readable medium of claim 8, wherein a station that the transmitted packet was not directed to waits to send a separate packet until the transmitted packet is received.

15. An apparatus, comprising a detector to detect a power back-off initiated at a data portion of a transmitted packet.

16. The apparatus of claim 15, further comprising a processor to:
buffer incoming data of the data portion of the transmitted packet;
calculate a digital gain of the detected power back-off;
set the digital gain to properly receive the data; and
receive the data of the transmitted packet.

17. The apparatus of claim 15, further comprising a processor to:
receive an exact power back-off for each transmission rate;
determine a transmission rate for the transmitted packet;
set a digital gain according to the exact power back-off for the transmission rate; and
receive the data of the transmitted packet.

18. The apparatus of claim 15, wherein a station that the transmitted packet was not directed to waits to send a separate packet until the transmitted packet is received.

19. The apparatus of claim 15, wherein a preamble portion of the transmitted packet is digitally boosted and does not have power back-off.

20. The apparatus of claim 15, wherein the transmitted packet is a Orthogonal Frequency Division Multiplexing (OFDM) packet.

21. A system comprising:
a transceiver to transmit a packet having a preamble portion and a data portion, wherein only the data portion has a power back off; and
at least one dipole antenna coupled to the transceiver.

22. The system of claim 21 wherein the packet comprises an orthogonal frequency division multiplex (OFDM) packet including a physical convergence layer (PCLP) portion.

23. The system of claim 21 wherein the data portion has a power back off only when a data payload exceeds a threshold value.
